(19) United States
(12) Patent Application Publication
(10) Pub. No.: US 2002/0172769 A1
(43) Pub. Date: Nov. 21, 2002

(54) Protective masking device to be put on an engine block during thermally coating cylinder bores provided therein, and method using the protective masking device

(76) Inventors: Ralph Herber, Bad Sackingen (DE); Peter Zurcher, Dottikon (CH); Gerard Barbezat, Opfikon (CH)

Correspondence Address: Paul J. Maginot, Maginot, Moore & Bowman, Bank One Center/Tower, 111 Monument Circle, Suite 3000, Indianapolis, IN, 46204-5115, US

(21) Appl. No.: 10/068,699

(22) Filed: Feb. 6, 2002

(30) Foreign Application Priority Data
May 15, 2001 (CH) 0898/01

(51) Int. Cl. B05D 1/32; B05D 1/08

(52) U.S. Cl. 427/271; 427/282; 427/446; 118/317; 118/326

(57) ABSTRACT

A protective masking device adapted to rest on the upper surface of an engine block having cylinder bores during a thermal coating operation of the cylinder bores comprises a protective masking member having an essentially hollow cylindrical shape with an inner diameter selected in relation to the diameter of the cylinder bore to be thermally coated. The protective masking device comprises either an essentially tube shaped outer sleeve member and an insert member inserted into the outer sleeve member, or it is designed such that at least a portion of a layer or of several layers of coating material applied to the inner side of the masking device during the coating operation of the related cylinder bore is mechanically removable. Using the proposed masking device, the coating operation can be started outside the cylinder bore, without the danger that portion of the engine block or the environment is contaminated by coating particles.

### FIELD OF THE INVENTION

The invention refers to a protective masking device to be put on an engine block during thermally coating cylinder bores provided therein as well as to a method for thermally coating cylinder bores of engine blocks using a protective masking device according to the invention.

In the manufacturing of combustion engines, nowadays more and more engine blocks made of light alloys are used. Since light alloys generally do not exhibit a high resistance against abrasion and wear, the cylinder bores and their walls, respectively, are provided with a face layer, or liners are inserted into the cylinder bores, which, if necessary, are also provided with a face layer. The application of such face layers is usually performed by means of thermal coating processes, whereby particularly rotating plasmatrons have proven reliable for applying the layer. Amongst else, the problems during the application of such face layers may be seen in the fact that the entire face layer should be homogenous. Since an apparatus for thermal coating, for instance a plasma spraying apparatus, requires a certain rise time until a homogenous coating material jet is emitted, the thermal coating apparatus must be activated prior to inserting it into the cylinder bore, because, otherwise, an irregular initial layer would be created within the cylinder bore. Upon activating the thermal coating apparatus remote of the cylinder bore to be coated, however, the danger exists that machined surface portions -mating surfaces- of the engine block are contaminated by the coating jet in an undesired manner.

In order to circumvent this problem and to protect the engine block from a so-called “overspray”, flat protective masking devices are known which are put onto the surface of the engine block. Thereby, however, not all problems are solved, because the environment can be polluted by the coating apparatus started outside of the cylinder bore to be coated.

### Prior Art

The German Patent Document 199 10 665 discloses a masking template adapted to be put onto the engine block of a combustion engine. This masking template comprises several passages or apertures through which a coating tool can be moved into the interior of the engine block. The masking template is designed such that all further portions of the engine block are covered by the template as well. For this purpose, the masking template comprises an exactly plane lower side which is adapted to rest on the already plane ground cylinder head surface of the engine block. It is understood that such a masking template is very expensive to manufacture. Moreover, it is not universally applicable since its size and shape has to be more or less exactly adapted to the size and shape of the engine block to be protected in order to cover all remaining areas of the engine block. Further, the lower side has to machined from time to time in order to keep it exactly plane. This is very important insofar as, in the case of a not exactly plane lower side of the masking template, coating material could reach the cylinder head surface of the engine block through a gap between masking template and engine block and contaminate it during the coating operation.

The Patent Abstract of Japan, Publication Number 06065711, discloses a masking device that is moved, from the bottom side of the engine block, towards the lower end of the cylinder bore. The protective mask is of a two-part design, having oblique separating faces between the two parts, in order to be able to move the two parts, shifted with regard to each other, through a narrow passage of the crankcase into the interior of the engine block. By means of this masking device, the interior of the engine block, particularly the crankcase, should be protected from contamination during the thermal coating of the cylinder bores.

### Objects of the Invention

Thus, it is an object of the invention to provide a protective masking device adapted to rest on the upper surface of an engine block having cylinder bores during a thermal coating operation of said cylinder bores which is suitable for multiple use and easy to apply, and which makes possible an activation of the thermal coating apparatus outside of the cylinder bore to be coated, without the danger that thereby the engine block or the environment are contaminated by coating particles, whereby simultaneously a high quality of the applied coat shall be ensured.

### SUMMARY OF THE INVENTION

In order to meet these objects, the invention provides, according to a first aspect, a protective masking device adapted to rest on the upper surface of an engine block having cylinder bores during a thermal coating operation of said cylinder bores. The protective masking device comprises a protective masking member having an essentially hollow cylindrical shape with an inner diameter selected in relation to the diameter of the cylinder bore to be thermally coated.

In one embodiment, the protective masking member comprises an essentially tube shaped outer sleeve and an insert member inserted into the outer sleeve. The insert member is loosely inserted in the outer sleeve to be vertically movable with regard to the outer sleeve. The insert member is provided with a stop member adapted to prevent the insert member from falling out of the outer sleeve.

In another embodiment, the masking device is designed such that at least a portion of a layer or of several layers of coating material applied to the inner side of the masking device during the coating operation of the related cylinder bore is mechanically removable.

In either case, the masking device has a height of between 10 and 60 millimeters, preferably between 20 and 40 millimeters, and it can comprise positioning means for positioning and/or fixing it with regard to the engine block.

According to a second aspect, the invention provides a method of thermally coating the cylinder bores of an engine block. The method comprises the steps of providing an engine block whose cylinder bores are to be thermally coated, providing a thermal coating apparatus having a coating head, providing a protective masking device comprising a protective masking member having an essentially hollow cylindrical shape with an inner diameter selected in relation to the diameter of the cylinder bore to be thermally coated, putting the protective masking device onto the upper surface of the engine block and aligning it with the cylinder bore to be thermally coated, moving the coating head of the thermal coating apparatus into the interior of the masking member, starting the thermal coating apparatus and aligning the position of the coating head such that the coating jet entirely hits the inner walls of the masking member, and moving the coating head into the cylinder bore to be coated once the coating jet has stabilized.

In contrast to the masking devices known in the prior art, the present invention departs from a different basic idea. Particularly, the invention suggests using a masking device that is of essentially hollow cylindrical shape, with an inner diameter adjusted to the diameter of the cylinder bore to be coated. Such a masking device does not cover the entire top surface of the engine block to be treated, but rests on an annular area thereof, located around the cylinder bore to be treated. Such a hollow cylindrical masking device has, amongst others, the advantage that it can be manufactured very easily and inexpensively, and that it rests reliably on the top surface of the engine block, without any gap, due to its comparatively small, annular rest area around the cylinder bore to be coated.

Preferably, the height of the masking device is chosen such that it is greater than the vertical extension of the coating jet, the coating head of the coating apparatus being in the interior of the masking device. Thereby, the coating head can be inserted into the interior of the masking device when it is still shut-off and can be activated once being in the interior of the masking device.

Thereby, in a general sense, the quality of the entire coating operation can be considerably improved, since no contamination of the top surface of the engine block, caused by the coating particles emitted by the coating head, can occur. Moreover, a uniform coating of the wall of the cylinder bore is ensured since the coating operation is initialized outside of the cylinder bore such that a continuous coat transition from the masking device to the cylinder bore is achieved.

### BRIEF DESCRIPTION OF THE DRAWINGS

In the following, some embodiments of the protective masking device according to the present invention will be further described, with reference to the accompanying drawings, in which:

FIG.1 shows a cross sectional view of an engine block with a first embodiment of the protective masking device according to the invention;

FIG. 2 shows a cross sectional view of an engine block with a second embodiment of the protective masking device according to the invention; and

FIG. 3 shows a cross sectional view of an engine block with a third embodiment of the protective masking device according to the invention.

### DETAILED DESCRIPTION OF THE PREFERRED EMBODIMENTS

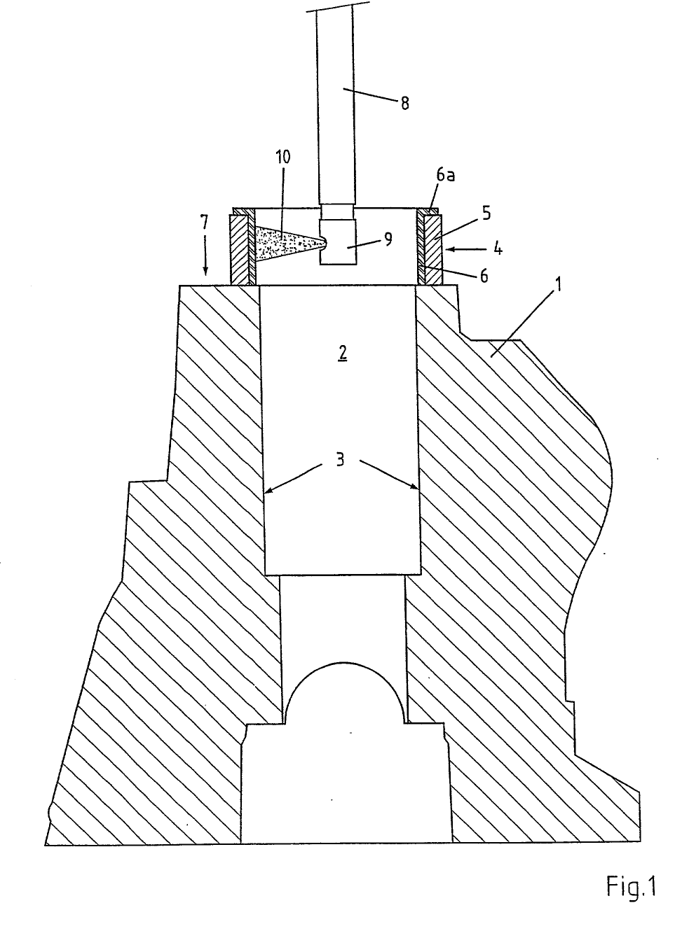

FIG. 1 schematically shows a cross sectional view of an engine block 1 of an in-line engine, a protective masking device 4 resting on the upper surface 7 of the engine block 1 as well as the front portion 8 of a coating apparatus. As a coating apparatus, for example a plasma spraying apparatus having a rotating coating head 9 can be provided. That kind of plasma coating apparatus being well known in the prior art removes the need to further explain its design and operation.

The engine block 1 comprises a plurality of cylinder bores, whereby in this illustration only one cylinder bore 2 is visible. The protective masking device 4, fixed to the upper surface 7 of the engine block 1 and being in coaxial relationship with regard to the cylinder bore 2, comprises a tube shaped outer portion 5 and an insert member 6 with essentially hollow cylindrical shape. The size of the protective masking device 4 as well as the diameter of its insert member 6 is selected according to the diameter of the cylinder bore 2 to be coated. In the present example, the inner diameter of the insert member 6 is slightly greater than the diameter of the cylinder bore 2. Since the insert member 6 is also coated at the beginning of the coating operation of the cylinder bore 2, as will be further explained herein after, its inner diameter changes more and more during its use, i.e. the inner diameter of the insert member 6 decreases the longer it is used. In the present example, the insert member 6 is designed as a limited use component that is usually discarded after one to ten applications.

By providing the protective masking device with an insert member 6, the need is removed to exchange the entire protective masking device 4, but only the insert 6, after one or a certain number of coating operations. The insert member 6 is preferably made of a metallic, ceramic or organic material, or of a combination of these materials. The height of the protective masking device 4 normally amounts to between 20 and 40 millimeters. Anyway, its height is chosen such that the coating powder jet 10, as shown in the drawing, entirely hits the inner wall of the insert member 6 when the coating head 9 is moved into the interior of the protective masking device 4. Due to the fact that the coating head 9 is moved into the protective masking device 4 and that the coating apparatus is activated only thereafter, i.e. when the coating head 9 is located in the interior of the protective masking device 4, it is ensured that no considerable pollution of the environment by the coating particles takes place. After the coating apparatus having been activated, and once its operation having been stabilized, the coating head 9 can be slowly moved into the cylinder bore 2. Thereby, the cylinder bore 2 and its walls 3, respectively, is continuously coated and there is no irregular initial coating layer.

Preferably, the insert member 6 is loosely received in the outer portion 5 of the protective masking device 4 such that the insert member 6 is movable in vertical direction with regard to the outer portion 5 of the protective masking device 4. In order to avoid that the insert member 6 falls out of the outer portion 5, for example in the case when the protective masking device 4 is removed from the upper surface 7 of the engine block 1, the insert member 6 is provided with a stop member in the form of a circumferential shoulder 6a located at the upper end of the insert member 6 and projecting radially outwards. Advantageously, the insert member 6 is somewhat higher than the outer portion 5 of the protective masking device 4 with the result that it rests on the upper surface 7 of the engine block 1 once the protective masking device 4 rests on the top of the engine block 1, thereby avoiding that the shoulder 6a rests on the upper edge of the outer portion 5 of the protective masking device 4. Thus, on the one side, it is ensured that the insert member 6 securely rests on the upper surface 7 of the engine block 1 without a gap between insert member 6 and engine block 1; on the other side, the insert member can be exchanged very quickly and easily. Moreover, by providing insert members 6 having different inner diameters, but the same outer diameter, the protective masking device 4 can be easily adapted to engine blocks 1 having cylinder bores 2 of different diameters.

The protective masking device 4 can be provided with positioning means for aligning and/or fixing it to the engine block 1. For this purpose, for example pins or bolts can be provided which engage bores provided in the engine block 1. However, both the positioning means and the bores provided in the engine block 1 are not shown in the present example.

The application of the coating layer is preferably performed by plasma spraying, high speed flame spraying, arc spraying, flame spraying, inert gas plasma spraying or inert gas arc spraying.

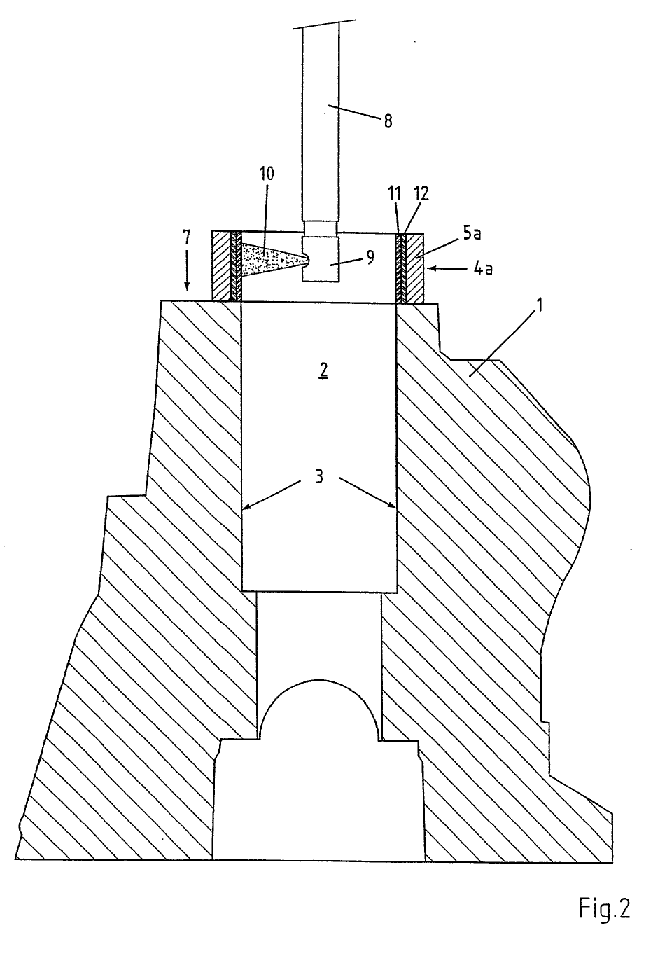

FIG. 2 shows a cross sectional view of the engine block 1 with a second embodiment of a protective masking device 4a. The protective masking device 4a again is in the general shape of a tube, i.e. essentially in the shape of a hollow cylinder. In contrast to the embodiment shown in FIG.1 and described herein before, no insert member is provided. However, the protective masking device 4a is designed such that the coating layers 11, 12 applied to its inner walls during the operation of coating the corresponding cylinder bore 1 can be mechanically removed, if necessary, for instance by machining the outer portion 5a of the protective masking device 4a on a lathe. A removal of the coating layers 11, 12 can also be performed by blasting with abrasive powders, as for example corundum (Al₂O₃) or silicon carbide (SiC)

The inner diameter of the protective masking device 4a is preferably somewhat greater than the diameter of the cylinder bore 2, such that the coating layers 11, 12 have not to be removed completely, i.e. down to the inner diameter of the outer portion 5a of the protective masking device 4a; this could be hardly done without damage to or weakening of the protective masking device 4a. With regard to the present example, it would be sufficient to remove only the inner layer 11.

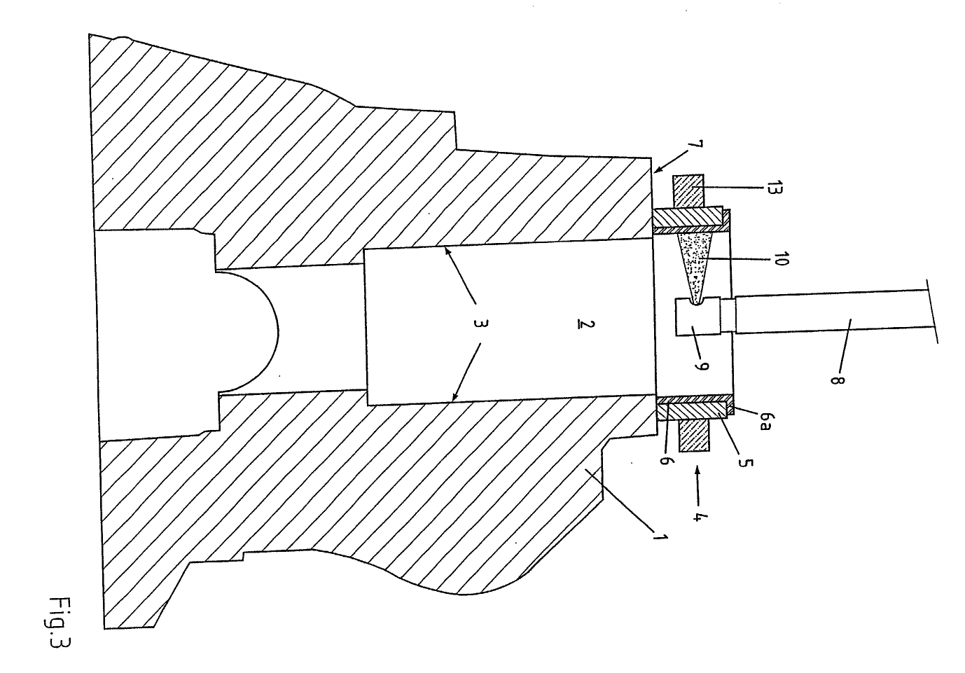

FIG. 3 shows a third embodiment of the invention. In this embodiment, a protective masking device assembly is provided, comprising a plurality of protective masking devices 4 and a frame member 13 holding the individual protective masking devices 4 in place. The distance between the individual protective masking devices 4 corresponds to the distance between adjacent cylinder bores 2 of the engine block 1. The design of the individual protective masking devices 4 essentially corresponds to the design described in connection with FIG. 2, whereby it is ensured, again that the protective masking devices 4 and their insert members 6, respectively, rest on the upper surface 7 of the engine block 1 essentially only along a circular area around the periphery of the cylinder bore 2 to be provided with a coating layer.

Preferably, air is flowing through the cylinder bore 2 actually being processed during the coating operation, by extracting air from the lower side of the cylinder bore 2 by means of not further shown air suction means. An extraction of the air from the lower side of the cylinder bore 2 has the advantage that the coating particles not adhering to the wall of the cylinder bore 2 being processed are reliably removed. Moreover, by providing a preselected flow of air through the cylinder bore 2 being processed, the content of oxygen bound in the coating layer (oxide portion) can be influenced in a defined manner.

Moreover, for selectively influencing the characteristics of the coating layer, it is also possible to lead, instead of air, nitrogen or another gaseous medium through the cylinder bore actively being processed. The provision of a protective masking device 4, 4a designed according to the invention has an advantage in this respect insofar as more favorable flow conditions are created within the cylinder bore 2 than without a protective masking device, resulting in a more uniform quality of the applied coating layer. It is understood that the three embodiments as shown herein cannot be considered as final. For example, protective masking device assemblies in the sense of a multiple protective masking device can be provided as well, since frequently two coating apparatus are operated simultaneously. The distance between the protective masking devices, thereby, is adjusted to the distance between the cylinder bores of the engine block, whereby usually not the immediately adjacent cylinder bores are simultaneously processed, but for example in a four cylinder in-line engine, first the bores 1 and 3 and then the bores 2 and 4.

What is claimed is:

1. A protective masking device adapted to rest on the upper surface of an engine block having cylinder bores during a thermal coating operation of said cylinder bores, comprising a protective masking member means having an essentially hollow cylindrical shape with an inner diameter selected in relation to the diameter of the cylinder bore to be thermally coated.

2. A protective masking device according to claim 1 in which said protective masking member means comprises an essentially tube shaped outer sleeve means and an insert means inserted into said outer sleeve means.

3. A protective masking device according to claim 1 in which said protective masking member means is adapted to rest on said upper surface of said engine block essentially along an annular area of said surface of said engine block, said annular area being in coaxial relationship with said cylinder bore to be coated.

4. A protective masking device according to claim 2 in which said insert means is adapted to rest on said upper surface of said engine block essentially along an annular area of said surface of said engine block, said annular area being in coaxial relationship with said cylinder bore to be coated.

5. A protective masking device according to claim 2 in which said insert means projects over said outer sleeve means at the bottom side thereof.

6. A protective masking device according to claim 2 in which said insert means is loosely inserted in said outer sleeve means to be vertically movable with regard to said outer sleeve means, said insert means being provided with a stop means adapted to prevent said insert means from falling out of said outer sleeve means.

7. A protective masking device according to claim 6 in which said stop means comprises a circumferential shoulder means located at the top of said insert means.

8. A protective masking device according to claim 1 in which said protective masking member means has a height which is selected such that it is greater than the maximal vertical extension of the coating jet when a coating head of a thermal coating apparatus is moved into the interior of said protective masking member.

9. A protective masking device according to claim 2 in which said insert means is made of a metallic, ceramic or organic material or of a combination of said materials.

10. A protective masking device according to claim 1 in which the masking device is designed such that at least a portion of a layer or of several layers of coating material applied to the inner side of the masking device during the coating operation of the related cylinder bore is mechanically removable.

11. A protective masking device according to claim 1 in which said masking device has a height of between 10 and 60 millimeters, preferably between 20 and 40 millimeters.

12. A protective masking device according to claim 1 in which said masking device comprises positioning means for positioning and/or fixing it with regard to the engine block.

13. A protective masking device assembly adapted to rest on the upper surface of an engine block having cylinder bores during a thermal coating operation of said cylinder bores, comprising at least two protective masking member means each having an essentially hollow cylindrical shape with an inner diameter selected in relation to the diameter of the cylinder bores to be thermally coated.

14. A method of thermally coating the cylinder bores of an engine block, comprising the steps of:
Providing an engine block whose cylinder bores are to be thermally coated;
Providing a thermal coating apparatus means having a coating head means;
Providing a protective masking device comprising a protective masking member means having an essentially hollow cylindrical shape with an inner diameter selected in relation to the diameter of the cylinder bore to be thermally coated;
Putting said protective masking device onto the upper surface of said engine block and aligning it with the cylinder bore to be thermally coated;
Moving said coating head means of said thermal coating apparatus means into the interior of said masking member means;
Starting said thermal coating apparatus means and aligning the position of said coating head means such that the coating jet entirely hits the inner walls of said masking member means; and
Moving said coating head means into said cylinder bore to be coated once the coating jet has stabilized.

15. A method according to claim 13 in which a protective masking device is used that comprises an essentially tube shaped outer sleeve means and an insert means inserted into said outer sleeve means, comprising the step of discarding said insert means after one to ten coating operations and replacing it by a new one.

16. A method according to claim 14 in which the layer or layers of coating material applied to the inner wall of said protective masking device during said coating operation is at least partially mechanically removed after one to ten coating operations.

17. A method according to claim 16 in which said layer or said layers are removed by blasting with an abrasive powder, particularly corundum (Al₂O₃) or silicon carbide (SiC).

18. A method according to claim 14 in which a thermal coating apparatus means having a rotating coating head means is used.

19. A method according to claim 14, further comprising the step of leading a flow of air through the cylinder bore that is subjected to the active coating operation.

20. A method according to claim 14, further comprising the step of leading a flow of nitrogen or another gaseous medium through the cylinder bore that is subjected to the active coating operation.

21. A method according to claim 14 in which the application of the coating layer is performed by plasma spraying, high speed flame spraying, arc spraying, flame spraying, inert gas plasma spraying or inert gas arc spraying.
